(19) United States
(12) Patent Application Publication
(10) Pub. No.: US 2017/0091279 A1
(43) Pub. Date: Mar. 30, 2017

(54) ARCHITECTURE TO FACILITATE ORGANIZATIONAL DATA SHARING AND CONSUMPTION WHILE MAINTAINING DATA GOVERNANCE

(71) Applicant: Immuta, Inc., Annapolis, MD (US)

(72) Inventors: Sapan SHAH, Annapolis, MD (US); Barry HAMMEN, Annapolis, MD (US); Michael HOWARD, Annapolis, MD (US); Kyle LILLY, Annapolis, MD (US); Eric PERRY, Annapolis, MD (US); Kris SIEGEL, Annapolis, MD (US); Adam YOHRLING, Annapolis, MD (US); Matthew CARROLL, Annapolis, MD (US); Michael SCHILLER, Annapolis, MD (US); Steve TOUW, Annapolis, MD (US); Jeffrey HASTINGS, Annapolis, MD (US); Catherine HOLMES, Annapolis, MD (US)

(21) Appl. No.: 15/278,693

(22) Filed: Sep. 28, 2016

Related U.S. Application Data
(60) Provisional application No. 62/233,843, filed on Sep. 28, 2015.

(51) Int. Cl. G06F 17/30; H04L 29/06

(52) U.S. Cl. CPC G06F 17/30477; H04L 63/10

(57) ABSTRACT

Embodiments of the present disclosure provide a novel technology and method for data owners to expose data and users to gain access to data within their enterprise while maintaining data governance policies required by the data owner. An example of the technology and methods are described herein which provides a technology agnostic framework that enables sharing and management of data across repositories, data formats, applications, and systems in the enterprise.

### RELATED APPLICATIONS

This application claims priority to U.S. Provisional Patent Application No. 62/233,843, filed Sep. 28, 2015, which is hereby incorporated by reference in its entirety.

### FIELD

Non-limiting embodiments of the present disclosure generally relate to improvements in managing and securing master data in an IT (Information Technology) system, and more particularly to architecture for securely accessing data across an enterprise.

### BACKGROUND

Organizations such as large enterprises and governments have large volumes of data often maintained in separate data repositories. Data governance policies vary between and even within those repositories. In order to derive more value from the data, the organization desires the capability to share the data with more people, to perform data analysis across multiple data repositories, to use familiar tools to access the shared data, and to perform this sharing in a manner that ensures each access of datum is performed in accordance with the governance policies required for that piece of datum to include, but not be limited to, such governance requirements as access control, access auditing, lineage tracking, data purge requirements, and data metrics requirements.

A unified view of data in an enterprise is created using Master Data Management (MDM). There are numerous standard methods of creating this view, the most common is for all data to be pushed to a centralized database and conform to a common ontology. With this method an enterprise is able to provide a single system of truth for which the enterprise can standardize around. However, one of the major drawbacks to this approach is that the access patterns of that data cannot be optimized for every type of query. Users also rely on the proper fields being extracted from the data and because it is a shared system all data sources are impacted by network performance.

Another challenge of MDM is that most data owners have a unique policy to grant and deny users access to the data. In this type of MDM, where everyone is consolidating to a single ontology, this policy enforcement is lost and must be standardized, removing the fine grained control that data owners would like. This hurts users as they sometimes will have to choose between getting a very broad summary of the data that the data owner has or a very small sampling of the data that the data owner has deemed that everyone can see. This also leads to the fact that the data owner has no way of tracking who is viewing their data and can lead to data breaches which can cause the enterprise to lose revenue.

However, MDM is a very important concept as enterprise users need to be able to see what data is available to create analytics to help the enterprise succeed. A need exists for a system which can allow users to gain access to raw data from remote repositories while still allowing data owners to have fine grained control over who can see the data and what data they are allowed to see.

### SUMMARY

Embodiments of the present disclosure provide a novel technology and method for data owners to expose data and users to gain access to data within their enterprise while maintaining data governance policies required by the data owner. An example of the technology and methods are described herein which provides a technology agnostic framework that enables sharing and management of data across repositories, data formats, applications, and systems in the enterprise.

In some embodiments, “technology agnostic” means that the data are exposed to consumers by creating a virtual file system, a virtual database, or a map reduce input format so that the consumers can use their current toolset without learning a new tool or a new API. In other embodiments, this term is given a broader meaning.

Embodiments of the present disclosure offer a solution which allows data owners to share their data with the analyst and data scientist community within an enterprise while still enforcing compliance policies, managing access, auditing utilization, and not adding any strenuous load to their existing systems. Rather than a classic pull approach implemented by classic data virtualization suites, embodiments of the present disclosure allow the data owners to simply push metadata about their raw data. This metadata will allow end users to discover the data that they want to use in their analytics, processes, or programs without having to download the actual data content.

Embodiments of the present disclosure work under the assumption that no two data owner policies are ever alike. A Policy Handler contains the specific access logic to the object (raw file) the specific user is trying to access. For instance, policies are enforced at a data object to user granularity. Data is used by the Policy Handlers to make those decisions. Those data points are the visibility label of that data object and the user's authorizations. Using those two data points, the Policy Handler responds with either approved or denied access.

In order to enable a simplified form of getting to the data in the enterprise, embodiments of the present disclosure provide an implementation of a file system so that users can interact with the data from remote systems just as if they were files in their operating system. The file system will also take care of only displaying only the files that the user is allowed to access, and will filter the out the data that they cannot.

One aspect of the present disclosure relates to a file system view of an enterprise's unified data.

Another aspect of the present disclosure relates to a virtual file system representing an enterprise's unified data where the cache of external data is stored within client file systems and transferred between those client file systems via P2P communications.

Yet another aspect of the present disclosure relates to on demand/smart “hydration” of an enterprise data lake based on users requests for data from original sources which maintains the original security controls of the data sources.

In one embodiment, techniques disclosed herein may be realized as a method for data management and unified data access. According to the method, a request from a user to access a data object may be received. The data object may be stored in a remote data system, external to a file system of the user. Authorizations associated with the requesting user may be retrieved. Metadata associated with the data object may be retrieved. The metadata may comprises data visibility information comprising a reference to a policy, such that the data object does not need to be updated when the policy changes. Based on the user's authorizations, the data visibility, and a service call to a remote system that instantiates a static or dynamic policy, whether the user has access to the data object may be determined. If the user is determined to have access to the data object, access to the data object access to the data object may be granted to the user. The data object may not be fetched from the remote data system until the user requests to open the data object. The data object may be presented to the requesting user via a standard file system interface regardless of remote storage technology and including when the remote storage technology is a SQL database and the file object accessed by the user must be built from SQL query results.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. The drawings are not necessarily to scale, emphasis instead being placed upon illustrating the principles of the teachings. The drawings are not intended to limit the scope of the present teachings in any way.

FIG. 1 illustrates a block diagram depicting a data management system in accordance with an embodiment of the present disclosure, showing an exemplary process flow for fetching a blob.

FIG. 2 illustrates a non-limiting embodiment of a blob metadata entry.

FIG. 3 illustrates a non-limiting workflow that is used to determine if a user is authorized to see a blob.

FIG. 4 illustrates an overview of the challenges that the present disclosure is addressing.

FIG. 5 illustrates exemplary operations in accordance with an embodiment of the present disclosure.

FIG. 6 illustrates an exemplary use case in accordance with an embodiment of the present disclosure.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

All scientific and technical terms used herein are intended to have the same meaning as commonly understood by one of ordinary skill in the art. References to techniques employed herein are intended to refer to the techniques as commonly understood in the art, including variations on those techniques or substitutions of equivalent or later-developed techniques which would be apparent to one of skill in the art.

In some embodiments:
the term “blob” refers to some data which is stored on system where the technology that stores can be but not limited to SQL Databases, NoSQL databases, file systems, or computer RAM;
the term “metadata” refers to attributes of the blob.
the term “visibility” refers to attributes which may come from the data or blob that determine whether or not the user can see a blob.
the term “policy” refers to a set of guidelines which determine whether or not a user is allowed to see a particular blob or not.
the term “blob identifier” refers to a unique sequence of characters which indicates the name of the blob.
the term “data source” refers to a location which contains digitized data. The data source also has a unique identifier like the blob identifier.

In other embodiments, the terms above have different or broader meanings.

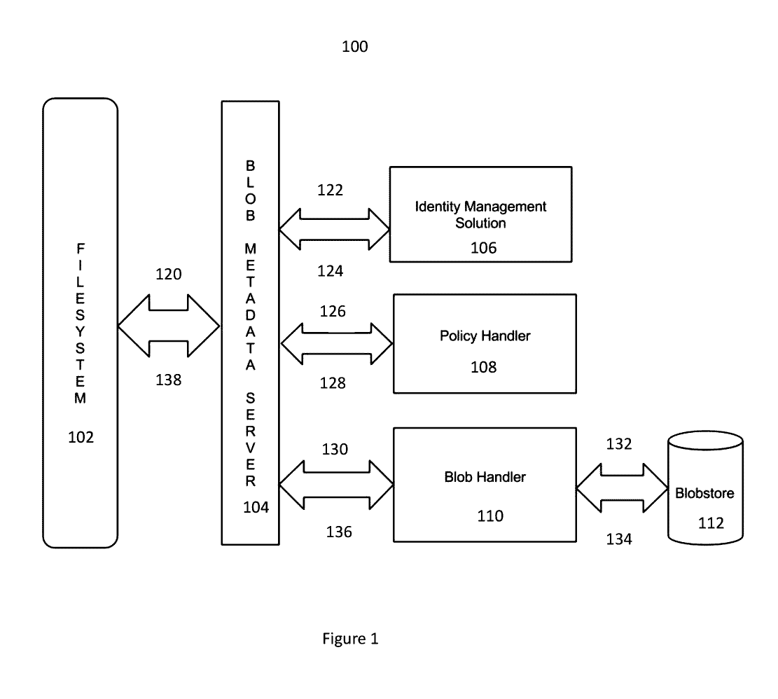

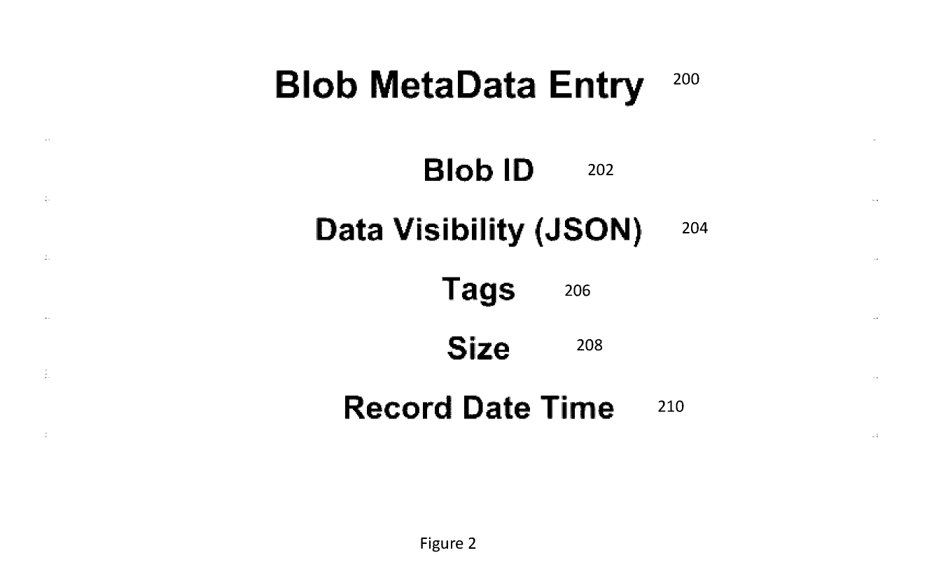

An illustrative embodiment of the present disclosure comprises the following components as illustrated in FIG. 1. In some embodiments, the data management system 100 may comprise file system 102, blob metadata server 104, identity management solution 106, policy handler 108, blob handler 110, and blob store 112. File system 102 may be a logical grouping of directory and file objects. The user may interact with the file system 102 like they would with a normal file system which is present on computing devices today. They are able to navigate and traverse directories as well as see the output of files. The file system 102 may be backed by visibility technology so that a user only has access to files that they are allowed to see. Blob metadata server 104 may handle indexing blob metadata so that they can be queried by the file system in an efficient manner. An embodiment of the blob metadata object is illustrated in FIG. 2. However there can be an arbitrary set of fields inside this object to help determine if a component has visibility.

With continued reference to FIG. 1, identity management solution 106 refers to a system which is used to authenticate that a user is who they say that they are. Identity management solution 106 may also handle managing the user's authorizations as well. This system will also keep track of which users have access to which data sources.

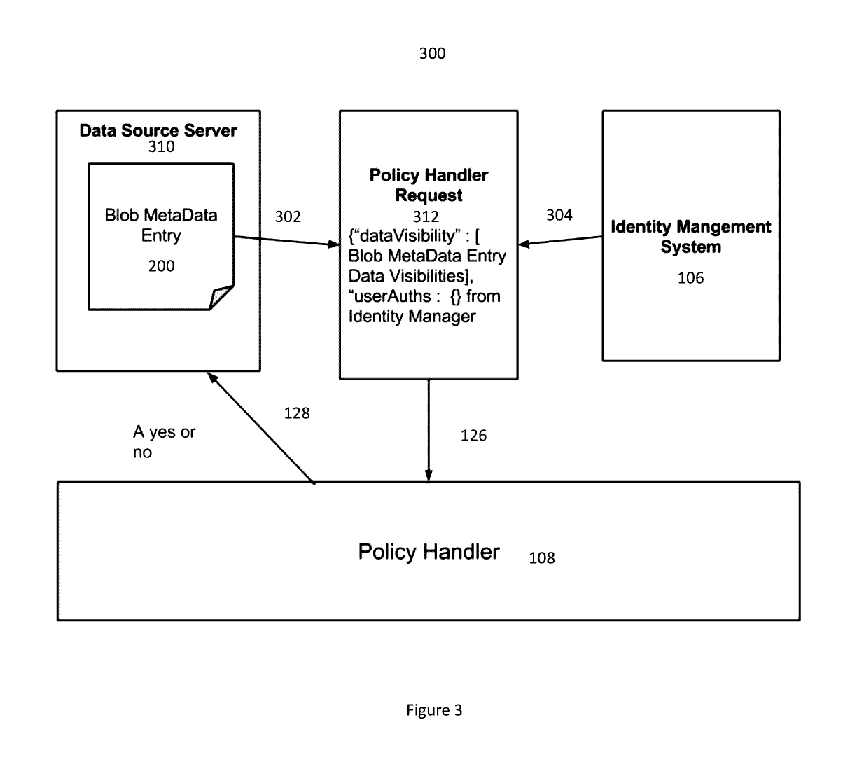

A policy handler 108 may be a system that a data owner creates which will enforce a policy through a computer program. With additional reference to FIG. 3, in a non-limiting embodiment, the policy handler may determine whether or not a user can see a blob. A blob handler 110 may handle fetching blobs of data from a blob store 112. The blob store 112 is where the blobs are stored by the data owner, which can be but is not limited to a database.

The file system 102 can be any type of user defined file system, such as, for example, a kernel module, FUSE File System, NFS Implementation, CIFS implementation, or Samba Implementation. The blob metadata server 104 can be any type of technology and is not limited to web services. The policy handler system 108 can be any type of technology and is not limited to web services. The blob store handler system 110 can be any type of technology and is not limited to web services, it can also be the frontend to any type of technology including but not limited to SQL databases, NoSQL databases, file systems, or a collection of websites. The directory structure for the file system can be exhibited in many different forms including but not limited to date, blob identifiers, or categories.

In one embodiment, data management system 100 may have an architecture that comprises a FUSE File system, a blob metadata management store web service, a policy handler web service, a blob store handler web service backed by a SQL database, and identity management solution web service. In this embodiment the directory structure of the FUSE file system will be done based on the date that is extracted from the blob metadata.

FIG. 1 also illustrates a non-limiting embodiment of a normal request workflow for a particular blob using the file system. When the file system 102 is mounted onto the user's system, it will gather the login credentials for the user. In this example embodiment, it will gather them from a file, but it is not limited to just this technique. After the file system 102 has gathered the login credentials, the file system implementation will contact the identity management solution 104, in order to authenticate the user. Once the user has been authenticated, the user can then start using the file system. The file system will fetch the data sources that the user has access too. At this point there are numerous paths that the user can take. In this section we will describe some of the common workflows that a user may take. In this example embodiment, a user will change into the top level directory which is the data source. Once the user does that, the file system 102 will talk to the corresponding blob metadata server 104 (via operation 120) to get the metadata, as seen in FIG. 2 of the blobs that the user is allowed to see. The blob metadata server 104 determines what the user is allowed to see by contacting the policy handler, via operation 126. To determine whether or not a user can see a blob, the blob metadata server 104 asks for the user's authorizations from the identity management solution, via operations 122 and 124. Blob metadata server 104 then sends those authorizations along with the blob visibility taken from the blob metadata to the policy handler 108. The policy handler takes this input and runs it through its guidelines or program, it will then return a yes or no answer to the blob metadata service, via operation 128. After obtaining the metadata, the file system implementation 102 will then go through and construct the directory structure that will be displayed to the user. As the user traverses through the directories, the blob metadata representation is transformed into a file object. Some of the attributes of the blob metadata can be set on the file object directly such as the date and the size. However other attributes are set on the file object using the extended attribute system that most modern operating systems implement. The user can view the object and treat it like a file. When the operating system opens up the file, the file system 102 will call out to the blob metadata server 104 which in turn will contact the blob store handler 110 and transfer the file from blob store 112 to the user's system. Data request to and return from blob handler 110 and blob store 112, via blob metadata server 104 and file system 102 may be achieved via operations 120, 130, 132, 134, 136, and 138.

Embodiments of a data unification architecture (DUA) described herein broker data access to organizational data sources and allows for the publishing of derived data sources based on data policy markings, user authorizations, and policy handlers which approve or reject data access based on data markings, user authorizations, and the current state of the dynamic policy or dynamic policies. Because data markings are references to policies and because policies, in combination with user permission to access a data source and specific authorizations related individual record access, are evaluated upon request for data access, data records need not be updated in bulk any time an access policy changes. The policies may relate to individual user access, group access, group memberships of a user potentially including legal authorities, security clearance and/or compartment memberships, access to data requiring specialized training, geographic location of the data, geographic location of the user, geographic location of the data owner, laws related to geographic restrictions on data transfer, or combinations of the aforementioned describable by Boolean logic or describable via a computer programming language. Raw data is not necessarily stored within the embodiment of the DUA, but is stored within data silos, such as, but not limited to, databases, network file systems, cloud data repositories, network attached storage, local file systems, web servers, SharePoint servers, and access to the raw data is provided via a blob handler capable of fetching the raw records from the data repository upon the request of the DUA embodiment

In some embodiments, the DUA allows for and may include mechanisms for data storage allowing data publishers to store raw data directly within the embodiment. For example, the DUA allows for and may include a mechanism to store each raw record or partial raw record in an encrypted manner with a key not written to physical storage on the computer or computers where the record or partial record is stored and where each record or partial record may be encrypted with a different key.

In some embodiments, the DUA allows for and may include mechanisms to cache raw records internal to the DUA so that such records need not be fetched from blob handlers and the data stores backing such handlers that are external to the DUA. Policies may describe what data may be cached, for how long, for what user or access policies, and whether the cache must validate with the blob handler whether the raw record has changed before presenting the cached copy to the requestor. Subject to policy handlers, the caching of raw records or partial raw records may be performed in an artificially intelligent manner to attempt to maximize the number of cache hits and minimize the number of cache misses based on available cache space, both RAM and persistent space, usage patterns, heuristics, and machine learning algorithms.

In some embodiments, the DUA includes a mechanism to allow data publishers to register data sources, assign one or more blob handlers, policy handlers, tag handlers, approve and reject data maskers, approve and reject users requesting access, delegate administration of the data source, audit access to records of the data source, and view metrics collected on the usage of the data source.

In some embodiments, the DUA includes a mechanism to allow data publishers to publish individual records, called blobs, by providing a metadata structure related to each to include a unique identifier and access policy description. The DUA allows for and may include a mechanism to specify parameters to connect to common underlying storage such as, but not limited to, databases, network file systems, cloud data repositories, network attached storage, local file systems, web servers, SharePoint servers and crawl such stores for blobs to register with the DUA and automatically perform the registration of the blobs as well as update registrations of those blobs to include the registration of new blobs as they become available and old blobs as they are removed. The DUA allows for and may include the ability to integrate the crawler into the DUA either as a built-in component of the DUA or by allowing users of the DUA to supply code, executables, containers, system images, or virtual machine images to be executed by the embodiment to perform the function. The DUA allows for and may include a mechanism to allow users to register the crawlers executing external to the embodiment but with the parameterized display of the crawlers visually integrated into the user interface of the embodiment.

In some embodiments, the DUA allows for and may include a mechanism to integrate policy handlers into the DUA embodiment either as a built-in component of the DUA or by allowing users of the DUA to supply code, executables, containers, system images, or virtual machine images to be executed by the embodiment to perform the function.

In some embodiments, the DUA allows for and may include a mechanism to select from a variety of common policy handler classes, such as but not limited to role based or attribute based policy classes, specify policy parameters for a data source and configure the DUA to enforce the selected and configured policy for the data source. The DUA allows for and may integrate policy handlers into the DUA embodiment either as a built-in component of the DUA or by allowing users of the embodiment of the DUA to supply code, executables, containers, system images, or virtual machine images to be executed by the embodiment to perform the function. The DUA allows for and may include a mechanism to allow users to register parameterized policy handlers executing external to the embodiment but with the parameterized display of the handlers visually integrated into the user interface of the embodiment.

In some embodiments, the DUA includes a mechanism to allow data publishers to publish one or more features derived from individual records (blobs) by providing a metadata structure related to each to include a blob reference identifier and access policy description. The DUA allows for and may include a mechanism to specify parameters to convert common blob types such as, but not limited to, images, videos, sound recordings, disk images, files, object relational mappings, and structured documents into features and register the features with the DUA and therefore the individual records may be crawled for extraction of features. The DUA allows for and may include the ability to integrate the crawler into the DUA embodiment either as a built-in component of the DUA or by allowing users of the embodiment of the DUA to supply code, executables, containers, system images, or virtual machine images to be executed by the embodiment to perform the function. The DUA allows for and may include a mechanism to allow users to register the crawlers executing external to the embodiment but with the parameterized display of the crawler visually integrated into the user interface of the embodiment.

In some embodiments, the DUA includes a mechanism to allow data publishers to assign one or more services, called tag handlers, to process the blobs from a data source and generate a set of tags or labels for each blob based on the content of the blob. The DUA contains a mechanism allowing users to search for data sources and blobs by tags and such tag-derived information such as but not limited to count of a tag or tags, absence of a tag or tags, number of tags. The DUA allows for and may include a mechanism to specify parameters to derive tags from common blob types such as, but not limited to, images, videos, sound recordings, disk images, files, object relational mappings, and structured documents into tags and register the features with the DUA and therefore the individual records may be crawled for extraction of tags. The DUA allows for and may include the ability to integrate the crawler into the DUA embodiment either as a built-in component of the DUA or by allowing users of the embodiment of the DUA to supply code, executables, containers, system images, or virtual machine images to be executed by the embodiment to perform the function. The DUA allows for and may include a mechanism to allow users to register the crawlers executing external to the embodiment but with the parameterized display of the crawlers visually integrated into the user interface of the embodiment.

In some embodiments, the DUA allows for and may include a mechanism to mask sensitive fields such as, but not limited to, fields related to personally identifiable information, fields deemed sensitive by regulation such as but not limited to HIPAA, fields subject to government classifications, fields deemed sensitive by corporate policy. The source data for the mechanism is either an aforementioned blob or aforementioned feature with the destination of the masked data is one of either a blob or feature. For a given value to be masked, the masked value in the output is identical across either all data within the DUA or a configurable portion thereof. In some instances, an unmasked value cannot be derived from a masked value, or cannot be derived from a masked value without knowledge of a secret. In some implementations, the operation of masking the data from a data source creates a derivative data source. In some implementations, the masked data from one data source by default inherits the policy markings of the original data. In some implementations, the data publisher of the original data can approve a new policy for each masked record. In some implementations, the data publisher of the original data can approve a new policy handler for the derived data source. In some implementations, access to the derivative data source is included in the audit records of the source data source. In some implementations, the DUA allows for and may include a mechanism to specify parameters to mask common blob or feature types such as, but not limited to, images, videos, sound recordings, disk images, files, object relational mappings, and structured documents. In some implementations, the DUA allows for and may include the ability to integrate the masker into the DUA embodiment either as a built-in component of the DUA or by allowing users of the embodiment of the DUA to supply code, executables, containers, system images, or virtual machine images to be executed by the embodiment to perform the function. In some implementations, the DUA allows for and may include a mechanism to allow users to register the maskers executing external to the embodiment but with the parameterized display of the masker visually integrated into the user interface of the embodiment.

In some embodiments, the DUA allows for and may include a mechanism to translate the blobs and/or features of a data source into a derivative data source comprised of blobs and/or features. The DUA may enforce the same policy handler for the derivative data source as the parent data source. The translator may exclude some records from the originating data source in creation of the derivative data source. The DUA may apply the same policy marking to the derived record as was in the source record. The DUA allows for and may include a mechanism to specify parameters to translate common fields within features or blobs such as, but not limited to, phone number or address, from a data source to a derived data source. The DUA allows for and may include the ability to integrate the translator into the DUA embodiment either as a built-in component of the DUA or by allowing users of the embodiment of the DUA to supply code, executables, containers, system images, or virtual machine images to be executed by the embodiment to perform the function. The DUA allows for and may include a mechanism to allow users to register the translators executing external to the embodiment but with the parameterized display of the translator visually integrated into the user interface of the embodiment. In some implementations, access to the derivative data source are included in the audit records of the source data source. In some implementations, masking could be performed as a step preceding or following the translation.

In some embodiments, the DUA allows for and may include a mechanism to allow users to combine two data sets to produce an aggregated derivative data source. The joining of data sources may include the masking or translating of a data source prior to or after the joining. The joining of data sources may include the combining of individual records based on fields within each record of one source that match fields within the records of the other source. The DUA allows for and may include a mechanism to specify matching parameters to join on common field values within features or blobs. The DUA allows for and may include the ability to integrate the joiners into the DUA embodiment either as a built-in component of the DUA or by allowing users of the embodiment of the DUA to supply code, executables, containers, system images, or virtual machine images to be executed by the embodiment to perform the function. The DUA allows for and may include a mechanism to allow users to register the joiners executing external to the embodiment but with the parameterized display of the joiner visually integrated into the user interface of the embodiment. In some implementations, access to the derivative data source are included in the audit records of both source data sources. In some implementations, access to individual records within the derivative data source must be approved by the policy handlers of both originating data sources.

In some embodiments, the DUA provides a triggering mechanism. In one embodiment, the DUA allows for and the embodiment thereof may include a mechanism for the DUA to notify external systems upon changes to data registered with the DUA.

In some embodiments, the DUA provides metrics. In one embodiment, the DUA allows for and the embodiment thereof may include a mechanism to analyze use of data including what data is accessed, how often it is accessed, what queries are run against it, and what users are accessing it.

In some embodiments, the DUA includes a mechanism for data publishers and system administrators to audit what data has been accessed by what user over a given time window and what users have accessed what data over a given time window. The DUA includes a mechanism to track accesses to derived masked, translated, and joined data. The DUA includes a mechanism to visualize and export the audit records.

In some embodiments, the DUA includes a mechanism for accessing blobs in such a way as to hide from the consumer the fact that the retrieved data may come from a cache internal to the embodiment, a blob store internal to the embodiment, or from a blob store that is an external service. The DUA allows for and may include a mechanism to allow users to access blobs without a new API by providing access to the blobs via a file system interface. The DUA allows for and may implement the file system as one of, but not limited to, a Linux, BSD, OS X, network (NFS, SMB, CIFS) Windows file system. As either a user space or kernel space file system. The DUA allows for and may cache blob data accessed or to be accessed via the file system on the computer instantiating or serving the file system by encrypting the blob data on local disk with a key never persisted to disk on that computer and with the data decrypted at access time by the file system. The DUA allows for and may include the ability for the file system to detect what system user or process is accessing the contents of the file system and approve or reject access to blobs based on the user performing the access, the process performing the access, or an ancestor process of the process performing the access. In some implementations, the blobs are transferred to the computer instantiating the file system in partial chunks so as to be able to provide access to blobs that exceed the local memory size and/or local file system size of the computer instantiating the file system. The DUA allows for and may include a mechanism to allow computers instantiating the file system to transfer blobs or portions of blobs between themselves in a peer to peer manner without the data passing through a server such that the latency of data fetches can be lower and the overall bandwidth transmitted to a node can be higher than would otherwise be possible. In some implementations, the accesses to blobs via the file system are recorded for audit and metrics purposes. In some implementations, the accesses to blobs and ability to see what blobs exist is determined based on the applicable policy handler. The DUA allows for and may include a mechanism to allow users to access blobs without a new API by providing access to the blobs via a HDFS system interface. In some implementations, the accesses to the blobs via the HDFS interface are recorded for audit and metrics purposes. In some implementations, the accesses to blobs and ability to see what blobs exist is determined based on the applicable policy handler. The DUA allows for and may include a mechanism to populate or hydrate a data lake by proxying access to a data lake or by integrating with the native security mechanisms of the lake. The embodiment may implement HDFS-based data lake hydration and allow for native tool access of data by copying each blob accessed by a user into HDFS upon first access. In some implementations, the accesses to blobs via the file system are recorded for audit and metrics purposes. In some implementations, the accesses to blobs and ability to see what blobs exist is determined based on the applicable policy handler.

In some embodiments, the DUA allows for and may include a mechanism to allow users to access features without a new API by providing access to the blobs via a PostgreSQL interface. In some implementations, the accesses to blobs via the file system are recorded for audit and metrics purposes. In some implementations, the accesses to blobs and ability to see what blobs exist is determined based on the applicable policy handler.

In some embodiments, the DUA provides a web based interface for the administration of Data Sources including, but not limited to, the ability for users to request access to a Data Source, the ability for an administrator to approve or reject user requests for access to a Data Source, the assignment of handlers described above and the performance of other administrative tasks previously described.

In some embodiments, the DUA allows for and may implement the ability for a user to change the role they are using to access data or their reason for accessing the data. This change may be a DUA-wide change or may result in the generation of additional authentication credentials specific for the role.

In some embodiments, the DUA allows for and may implement the ability for a user to specify authorizations that should not be considered when determining if the user should have access to data. This change may be a DUA-wide change or may result in the generation of additional authentication credentials specific for the scoped authorizations.

In some embodiments, the DUA allows for and may implement the ability to fetch user authorizations from multiple external identity management solutions including, but not limited to LDAP, Active Directory, and AWS IAM.

In some embodiments, the DUA allows for and may implement an identity management solution capable of storing user authorizations

In some embodiments, the DUA allows for and may implement mechanisms to encrypt all network traffic between DUA components, external systems, and consumers.

In some embodiments, the DUA allows for and may implement mechanisms to export data stored within the DUA to common external data stores such as but not limited to S3 buckets, file systems, and databases.

In some embodiments, through the DUA website/console and through the DUA API, a user can create multiple custom catalogs or sandboxes of data scoped by properties of the enterprise data including but not limited to: data time range, type of data, format of data, content-derived metadata, data source, whether or not the data has been transformed and how it has been transformed, whether or not the data has had sensitive fields masked, by removing some of the user's authorizations. In one embodiment, such catalogs/sandboxes can then be published for others to use, but scoped by each individual user's authorizations. In another embodiment, for use by an automated analytic or application such that said software sees only this scoped view of the data. In yet another embodiment, such catalogs can be updated with new data (or removal of old data) while in use.

In some embodiments, the DUA may feed information such as but not limited to information regarding new data sources, new data, data updates, data deletion, and data visibility changes, data policy changes to a reactive processing framework. Software running within that reactive processing framework can then take action on the information including propagating derived information back into a data source hosted within the DUA.

The reactive processing framework may be capable of passing the information to software running within the framework as individual events occur, or as certain criteria are met such as but not limited to volume of changed data, time since data was last passed to software within the framework, criteria involving analysis of the data or metadata.

The reactive processing framework may be capable of presenting data from the DUA or other inputs to software running within the framework as files within a file system or on standard input. The reactive processing framework may be capable of accepting output from the software running within the framework as files written out by said software or as output on standard output. The reactive processing framework may expose the data brokered by the DUA as a file system visible to software running within the framework. The reactive processing framework may be able to expose only certain catalogs/sandboxes of the data brokered by the DUA to the software running within the framework. The reactive processing framework will be able to map certain catalogs/sandboxes to specific pieces of software running within the framework based on the authorizations of the software or user launching the software and a profile for which catalog or catalogs the software may have access to all data and events presented by the reactive framework to the software running within that framework will follow the auditing and access rules of the data source within the DUA.

In some embodiments, in addition to the ability to allow data owners to publish blobs via the DUA by pushing metadata about the blob to the DUA embodiment, for data served up by queryable (via SQL, URL query parameters, REST, Elastic Search Query language, MongoDB Query language, and similar query languages recognizable by an expert in the art), the DUA allows the data owner to publish a query and associated metadata to be shared as a new data source within the DUA.

In some embodiments, to create a queryable data source within the DUA, the data owner (user with access and authority to share the original data) registers information necessary for the DUA embodiment to connect to the original data. Typically this would be a server name/address and port number, username, password, but could include any connectivity, access, and authorization necessary to retrieve data from a queryable source. For example, PKI could be used for access and authorization instead of username and password.

In some embodiments, in addition to connection information, the data owner provides query information. This could be as simple as providing the name of a database table, but could also be providing a SQL or other query language statement defining an exact query that should be represented as a data source within the DUA. It may also be the case that the DUA adapts a SQL query to a different query language. For example, the DUA may adapt a PostgreSQL statement to a statement in another version of SQL (such as that used by Microsoft, MySQL, MariaDB, Oracle, DB2, etc.) or it may convert SQL to another query language such as Elastic Search's, MongoDB's, Hive Query Language, Spark RDD operations, a data frame query, a map-reduce job, or similar query structure recognizable by an expert in the art.

In some embodiments, the DUA also allows for the data owner to provide information instructing the DUA to remove certain fields or columns from data returned to all end users.

In some embodiments, the DUA also allows for the data owner to provide information instructing the DUA to apply a policy to each consuming user's access to fields or columns within the returned data. The owner may specify the name of the field or column or the value of the field or column as one parameter to be evaluated during application of the policy, this parameter is termed column visibility. The accessing user's authorizations may make up another parameter to be evaluated during application of the policy. The owner may specify a policy handler which is a service responsible for applying the policy. That service may be part of the DUA or may be a separate service.

In some embodiments, the DUA also allows for the data owner to provide information instructing the DUA to apply a policy to each consuming user's access to records or rows within the returned data. The owner may specify the name of the field or column within the record/row or the value of the field or column within the row/record as one parameter to be evaluated during application of the policy, this parameter is termed “record visibility.”The accessing user's authorizations may make up another parameter to be evaluated during application of the policy. The owner may also specify an action for the field/column, determining whether the column would be masked (predictably hashed), truncated, be set to a specific value, be set to a computed value, or be set to a random value should the policy handler determine the policy applies to that user. The action can be applied to users determined to match the policy or to users determined to not match the policy. The owner specifies a policy handler which is a service responsible for applying the policy. That service may be part of the DUA or may be a separate service.

In some embodiments, the DUA also allows for the data owner to specify a directory representation (also known as file system representation) of the queryable data. To do this, the data owner may specify fields or columns within the data to be used as levels within a directory structure. If none are specified, the directory structure for that data source a single top level directory representing all data within that data source with each record represented by a file. The peer directories of this directory (for both queryable and non-queryable data sources) is the set or scoped (by authorization or filter) set of data sources within the DUA. When one or more columns/fields are selected to represent a level in the directory structure, DUA will produce a set of files (when there are no further levels in the directory structure) or directories, one for each unique value of the specified column or field. In the case where there are no further directory levels and the DUA produces a set of files, the file contents are not populated until a user opens the file in a file system view of the data or makes an API call to fetch the contents of that file. At that point, the DUA builds the file representation of the requested data by sending a query to service containing original data and building said query in a manner that restricts the records returned to the set where the set of column/fields associated with each parent directory level of the file equals the corresponding name of the directory at that level from the point of view of the file being accessed.

In some embodiments, while the user has a file system view of the data, file contents are not fetched, from queryable data services or blob handlers, until a user opens a file. At that point, the data is fetched from the external data service(s) and assembled into a single file for consumption by the user.

In some embodiments, in addition to the directory/file system representation of data that is common to both queryable and non-queryable data sources within the DUA, the DUA allows data consuming users to connect to the DUA with a SQL connection and run SQL queries against queryable datasource data and against features of non-queryable data sources.

In some embodiments, each time the user attempts to use the DUA to fetch a list of available records via the directory representation or the API where that list of available records could be the full list of directories and files, or a partial list of directories, or a partial list of files, or a partial list of files and directories, the DUA forwards the user authorizations and record visibility to the policy handler to determine if the user may see that record. The policy handler response will cause the DUA to remove any directories from the returned response which contain only files that the user does not have access to read. The policy handler response will also cause the DUA to remove any files from the returned response which contain no records that the user is authorized to read.

In some embodiments, each time the user attempts to use the DUA to fetch the contents of a file in the directory representation or download a blob from a queryable datasource via the API, the DUA forwards the user authorizations, record visibility, and column visibilities to the policy handler to determine if the user may see records grouped in that file. Files containing only records the user may not access are not presented to the user. Within the set of returned files, files for which the user is authorized to see at least one record, records which the user is not authorized to see are not assembled into the file for that user. The policy handler also returns the list of fields/columns which the user can see (or the list which they cannot). Within the set of returned records, fields/columns that have access policies are further processed by the DUA. Fields/columns that cannot be viewed by that user are then removed, masked (predictably hashed), truncated, set to a specific value, set to a computed value, or set to a random value for that user.

In some embodiments, the data available, both in terms of directories present, files present, and contents of the files may vary between users based on the evaluations made for that user by the policy handlers of the data sources accessible by the user.

In some embodiments, the format of the files created from queries is configurable. The format may be json, csv, tsv, xml, data frames, Spark RDDs or similar structured data formats.

In some embodiments, each time a user attempts to access queryable data sources via the SQL interface, the DUA applies the same policy controls to rows returned in response to SQL queries. The DUA forwards the user authorizations and row/record visibility and column visibility to the policy handler to determine if the user may see that record. The policy handler response will cause the DUA to remove any rows/records the response to the user that the user does not have authorization to view. Additionally, the policy handler response will also indicate which columns the user may see (or may not see). The DUA uses this list to remove, mask (predictably hash), truncate, set to a specific value, set to a computed value, or set to a random value for that user the contents of columns the user is not authorized to see.

In some embodiments, the DUA in the file system access method provides a single method and point of consumption for both queryable and blob-oriented data where for a given user all data is limited to what policies dictate should be available to that user.

In some embodiments, for queryable data sources, the DUA allows users to create additional data sources out of queryable data sources. This allows users to construct new queryable data sources that are joins or unions across original data sources, which may be across queryable technologies.

In some embodiments, for queryable data sources, the DUA allows users to create child data sources of one or more existing queryable data sources. During creation of the child data source, the user specifies the query statement to be applied to existing queryable data sources. Utilizing such a statement, the user can restrict the new data source to particular items of utility and/or create a join or union across multiple queryable data sources. In this case, the DUA does not require a policy handler be specified for the new child data source. Rather, the DUA applies all policy handlers of the original data source(s) that are part of the child data source. Additionally, the DUA does not grant a user access to the child data source unless the user has access to all data sources from which the child was created. And when a user requests access to a child data source, the DUA automatically generates access requests for that user to all data sources from which the child data source was created.

In some embodiments, in addition to the policy-based content modification of queryable data source data, the DUA also allows for policy based content modification of well-structured blobs. In this scenario, the data owner provides the DUA information about the structure of a set of blobs including data format (json, xml, csv, etc.), column visibility metadata, record visibility metadata, and policy handler information. The DUA then supplies the policy handler user authorizations, column visibility metadata, record visibility metadata, and the blob Id. The policy handler response indicates which rows/records of the blob the user may access and which columns of the record the user may see (or which columns the user may not see). The DUA then strips rows/records from the blob that may not be seen by the user and removes, masks (predictably hash), truncates, sets to a specific value, sets to a computed value, or sets to a random value for that user the contents of columns the user is not authorized to see.

FIG. 2 illustrates a non-limiting embodiment of a blob metadata entry. Blob metadata entry 200 may comprise blob ID 202, data visibility 204, tags 206, size 208, and record date time 210. In other words, a blob (e.g., a data object) may have metadata (e.g., attributes) comprising blob ID 202, data visibility 204, tags 206, size 208, and record date time 210. In some embodiments, blob ID 202 is an identifier associated with the blob. In some embodiments, data visibility 204 are attributes which may come from the data or blob that determine whether or not the user can see a blob. In one embodiment, data visibility 204 may be rule-based. In another embodiment, data visibility 204 may be based on one or more (e.g., combined) logic operations. Data visibility 204 may be represented in JSON. In some embodiments, tags 206 may be an annotation associated with the blob. Tags 206 may be assigned by a human being. Tags 206 may be automatically generated. In one embodiment, tags 206 may be derived based on common blob types. In some embodiments, tags 206 reflects at least one characteristic of the blob. In some embodiments, a blob may be associated with more than one tags. In one embodiment, different sections of a blob may be associated with different tags. Size 208 may indicate a size of a blob. Record date time 210 may indicate a date (e.g., a time-stamp) associated with the blob. In one embodiment, record date time may indicate the time that the record was created. In another embodiment, record data time may indicate the time that the record was updated (e.g., the most recent update).

FIG. 3 illustrates a non-limiting workflow that is used to determine if a user is authorized to see a blob. For workflow 300, to determine whether or not a user can see a blob, the data source server 310 asks for the user's authorizations from the identity management solution 106. Data source server 310 then sends those authorizations along with the blob visibility taken from the blob metadata entry 200 to the policy handler 108. In one embodiment, data source server 310 may communicate with blob metadata server 104 for blob visibility from blob metadata entry 200. As shown in FIG. 3, also corresponding to FIGS. 1 and 2, the blob visibility taken from the blob metadata entry 200 and user's authorizations from identity management solution 106 may be sent to the policy handler 108 via operation 126. In other words, via operations 302 and 304, blob visibility and user's authentication are combined in policy handler request 312 and sent to policy handler 108. The policy handler 108 takes this input and runs it through its guidelines or program, it will then return a yes or no answer to the blob metadata service, via operation 128. After obtaining the metadata, the file system implementation 102 will then go through and construct the directory structure that will be displayed to the user.

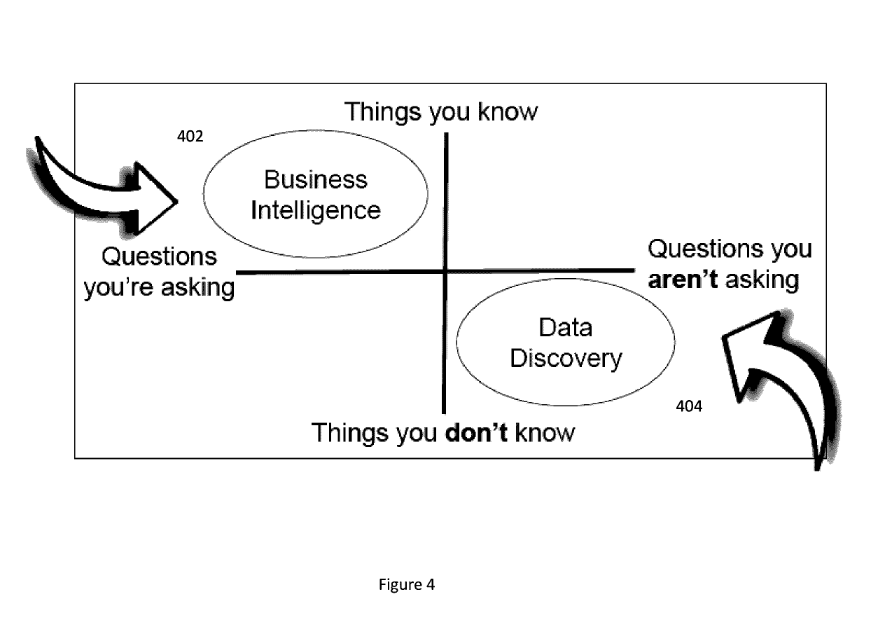

FIG. 4 illustrates an overview of the challenges that the present disclosure is addressing. Conventional business intelligence 402 focuses on questions that users ask and provide corresponding answers. Typically, data queries (e.g., questions that users are asking) may be structured, such as SQL-like queries. And the master data management (MDM) is focused on providing a “single truth.”There are several challenges for Big Data. For example, one challenge is the need to access raw data with complex security controls. Transforming data from a raw state to a state suitable for modeling and learning is “feature engineering” which is lost if working from MDM single truths (i.e., garbage in, garbage out). Another challenge is the need to support more complex processing tools. Data lake-ing may not solve Big Data due to the above challenges. Big Data management takes up-front political, organizational, and technical investment. Data discovery 404, as disclosed in various embodiments of present disclosure, focuses on questions that users are not asking. In other words, the present disclosure performs knowledge discovery intelligently, without necessarily a targeted question from the user.

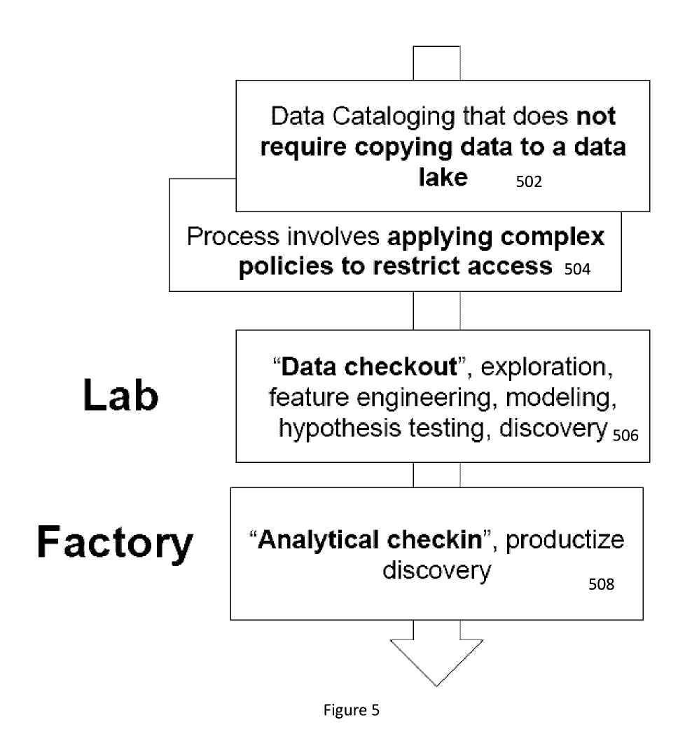

FIG. 5 illustrates exemplary operations in accordance with an embodiment of the present disclosure. As shown in 502, in some embodiments, data cataloging does not require copying data to a data lake. This is a lean and efficient approach that may lead to minimal up-front political, organizational, or technical investment. Data (e.g., client's data, data owned by an enterprise) may be unleashed immediately. At operation 504, in some embodiments, process (e.g., processing raw data) may involve applying complex policies to restrict access. At operation 506, “data checkout” (e.g., trial/lab phase) is performed. “data checkout” 506 may comprise exploration, feature engineering, modeling, hypothesis testing, and discovery. At operation 508, “analytical checking” (e.g., factory/production phase) is performed. “Analytical checking” 508 may comprise productizing discovery. As shown in FIG. 5, operations are efficient. In other words, raw data is exposed to data scientist at the lowest common denominator to enable any tool or process for experimentation. In one embodiment, no API is needed. Operations are also smart. Data transformation and analytic processing is promoted to production and the “data lake”: objective data lake hydration based on usage and value—data elasticity.

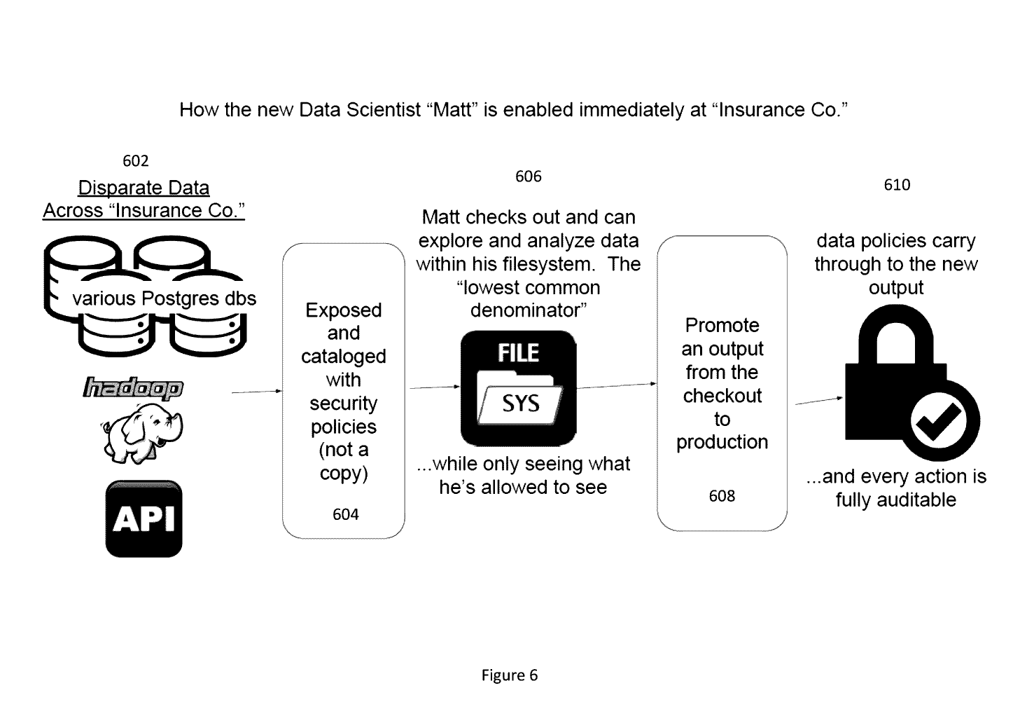

FIG. 6 illustrates an exemplary use case in accordance with an embodiment of the present disclosure. As shown in FIG. 6, the new data scientist “Matt” is enabled immediately at “Insurance Co.”, in accordance with an embodiment of the present disclosure. At operation 602, data sources are identified. For example, disparate data across various insurance companies are identified as data sources. The data may be stored in various Postgres databases. At operation 604, disparate data across various insurance companies are exposed and cataloged with security policies. As discussed above in relation to FIG. 5, disparate data across various insurance companies does not need to be copied to a data lake. Open-source data processing tools, such as Hadoop may be used at operation 604. In some embodiments, specific APIs may be used. At operation 606, Matt checks out and can explore and analyze data within his file system (i.e., the “lowest common denominator”). Matt may only see what he is allowed to see. At operation 608, also as discussed above in FIG. 5, an output from the checkout (e.g., trial phase) is promoted to production (e.g., factory phase). At operation 610, data policies are carried through to the new output (e.g., factory/production) and every action is fully auditable.

Cataloging data engineering is important because machine learning algorithm learns a solution to a problem from sample data. In this context, feature engineering should focus on: what is the best representation of the sample data to learn a solution to your problem: “Actually the success of all Machine Learning algorithms depends on how you present the data” Mohammad Pezeshzi; “You have to turn your inputs into things the algorithm can understand” Shayne Miel; “ . . . some machine learning projects succeed and some fail. What makes the difference? Easily the most important factor is the features used” Pedro Domingos;

While this specification contains many specific implementation details, these should not be construed as limitations on the scope of the present disclosure or of what may be claimed, but rather as descriptions of features specific to particular implementations of particular embodiments. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be used.

1. A method for data management and unified data access comprising:
receiving from a user a request to access a data object wherein the data object is stored in a remote data system, external to a file system of the user;
retrieving authorizations associated with the requesting user;
retrieving metadata associated with the data object, wherein the metadata comprises data visibility information comprising a reference to a policy, such that the data object does not need to be updated when the policy changes;
determining, based on the user's authorizations, the data visibility, and a service call to a remote system that instantiates a static or dynamic policy, whether the user has access to the data object; and
granting the user, if the user is determined to have access to the data object, access to the data object, wherein the data object is not fetched from the remote data system until the user requests to open the data object and wherein the data object is presented to the requesting user via a standard file system interface regardless of remote storage technology and including when the remote storage technology is a SQL database and the file object accessed by the user must be built from SQL query results.
